(19) United States
(12) Patent Application Publication
(10) Pub. No.: US 2015/0341282 A1
(43) Pub. Date: Nov. 26, 2015

(54) CONTEXT-AWARE PORTAL CONNECTION ALLOCATION

(71) Applicants: Lior Bar-On, Holon (IL); Rachel Ebner, Ra'anana (IL)

(72) Inventors: Lior Bar-On, Holon (IL); Rachel Ebner, Ra'anana (IL)

(21) Appl. No.: 14/285,369

(22) Filed: May 22, 2014

(51) Int. Cl. H04L 12/865; H04L 12/873; H04L 29/08

(52) U.S. Cl. CPC H04L 47/6275; H04L 67/10; H04L 47/522

(57) ABSTRACT

Various embodiments herein each include at least one of systems, methods, and software for context-aware portal connection allocation. Some embodiments operate to allocate a finite number of connections between a portal server and one or more backend systems. In some embodiments, a process that executes on a portal server determines a priority for a data processing request and allocates a data processing request to a connection queue based on the determined priority.

### BACKGROUND INFORMATION

Portal servers, also referred to as web portals, are commonly implemented to deliver access to software systems and services, including backend system applications and processes, of an organization over a network. Many users may access one or more portal servers of an organization during a period. As a result, some users may experience latency, in particular when attempting access to backend system resources as portal servers typically have access to only a finite number of backend system network connections, database connections, threads and other computing resources. While portal servers may provide a single point of access to computing resources of an organization, the centralized system architecture of a portal server implementation provides other challenges.

### BRIEF DESCRIPTION OF THE DRAWINGS

FIG. 1 is a logical block diagram of a computing environment, according to an example embodiment.

FIG. 2 is a logical block diagram of a computing environment, according to an example embodiment.

FIG. 3 is a block flow diagram of a method, according to an example embodiment.

FIG. 4 is a block flow diagram of a method, according to an example embodiment.

FIG. 5 is a block diagram of a computing device, according to an example embodiment.

### DETAILED DESCRIPTION

Portal servers, also referred to as web portals, are commonly implemented to deliver access to computing resources of an organization over a network. In particular, a portal server typically provides a single point of access to all or at least select applications, services, and information of the organization, some of which are provided by backend systems. The backend systems may include one or more of Enterprise Resource Planning (ERP), Customer Resource Management (CRM), Human Resource Management (HRM), Business Intelligence (BI), and Supply Chain Management (SCM) systems, among other system types.

Portal servers typically include a role management function that associates users with one or more roles assigned to respective users. When a user establishes a connection of their computing device with a portal server, the role management function typically associates an identity of the user with one or more roles assigned to the user based on role assignment data that is stored within or is accessible from the portal server. In various embodiments, role assignment data upon which the role management function associates users to roles may be shared between various systems of an implementing organization or may be present only for purposes of portal server operation.

In providing access to the backend system, the portal server may periodically experience heavy loads, such as on Monday mornings, month-end, and other periods where many users may access the portal and backend system resources simultaneously. The portal server, in providing backend system resource access, typically has a limited number of backend system connections that may be simultaneously established and utilized. The number of connections may be limited by constraints of the backend systems, such as actual or configuration imposed constraints due to hardware and licensing limitations. Such limited connection numbers affect all users and processes equally, regardless of importance of users, roles they fill, and data processing tasks requested.

One possible solution to this issue is to prioritize allocation of backend system hardware resources to one or more of users, roles associated with users as described above, and processes that are more critical (e.g., management personnel and time-sensitive tasks). However, backend system resource allocation cannot occur until a data processing request reaches the backend system from the portal server. As a result, backend system data processing requests may languish in a portal server connection queue before they reach a location where they may be given priority. Thus, simply adding hardware resources to backend systems, while providing some performance improvement, may also fall short in providing acceptable overall system responsiveness as critical data processing requests are not prioritized until they reach the backend system.

Various embodiments herein each include at least one of systems, methods, and software for context-aware portal connection allocation. Such embodiments operate to allocate a finite number of connections between one or more portal servers and backend systems. In some embodiments, a process that executes on a portal server determines a priority for a data processing request and allocates the data processing request to a connection queue based on the determined priority. In such embodiments, priority of backend system data processing requests occurs on the portal server such that data processing requests that are deemed more important are prioritized earlier, reach the backend system more quickly, and better match resource utilization to priorities of the implementing organization.

For example, a portal server may have a limited number of possible connections to a plurality of backend systems. As the backend system data processing request is received in the portal server, a priority is determined and the data processing request is placed in a connection queue that manages the limited number of connections with the backend system according to the determined priority. The connection queue may be a single queue and data processing requests with determined priority may be moved to a front of the queue. In other embodiments, there may be two or more connection queues where one connection queue has a highest priority and the other connections queues have lower priority. Each connection queue may manage a reserved number or percentage of possible connections. In other embodiments, connections may be allocated first to data processing requests in the highest priority queue, then to data processing requests in a next lower priority queue, and then downward in priority if there are more than two queues.

Priorities of data processing requests may be determined based on any number of factors, but the factors are typically related to factors that make certain data processing requests more or less critical or important. Critical and important are generally implementation or embodiment specific based on factors that may be defined by an implementing organization. For example, backend system data processing requests received from a user associated with a manager role may be considered more critical than data processing requests from a user associated with a clerk role. Another example may be that data processing requests for certain processes, such as month-end accounting processes, may be considered more critical than other processes. Factors such as from whom a data processing request is received, a backend system process requested, a date or time when a request is received, among other factors, may not only be considered independently, but also in different combinations in various embodiments, in determining criticality or importance for purposes of prioritizing data processing requests on a portal server.

In various embodiments, a system administrator may define and configure such prioritization factors within a portal server or data that is otherwise accessed by one or more portal servers for prioritization of backend data processing requests. In some embodiments, these factors may be stored in the form of rules that are used to evaluate requests in a sequential manner. When a rule is applied that indicates a request is of a particular priority, the request may be handled accordingly. In other embodiments, a plurality of rules may be applied to determine a priority score that is then compared against priority threshold values to determine the priority. In some such embodiments, the determination is made by a rule engine present on or accessible by a portal server that applies at least one rule to a received request to determine the priority.

In some of these embodiments, and others, rules may be in the form of data processing components, such as in the form of a rule plugin, that may be added to a portal server or other location that may be accessed by a portal server. Multiple plugins may be added to, or otherwise utilized by, a portal server. A plugin is generally a prioritization schema that defines how certain types of requests are to be prioritized. Some plugins may include many rules that may be applied to determine a user's context without regard to the user's role, such as by evaluating which processes or types of processes or tasks that user has been utilizing performing. In some embodiments, plugins may be configured, extended in whole or in part, overridden or otherwise modified in an object oriented sense, utilized as templates, and the like. By evaluating processes utilized and tasks performed, a real-time adaptive context of the user can be determined. Such plugins may be included in or added to a portal server and enterprise-class computing systems (i.e., ERP, CRM, HRM, BI, and SCM systems). In some embodiments, the plugins may be obtained as downloads from a website or online marketplace.

These and other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

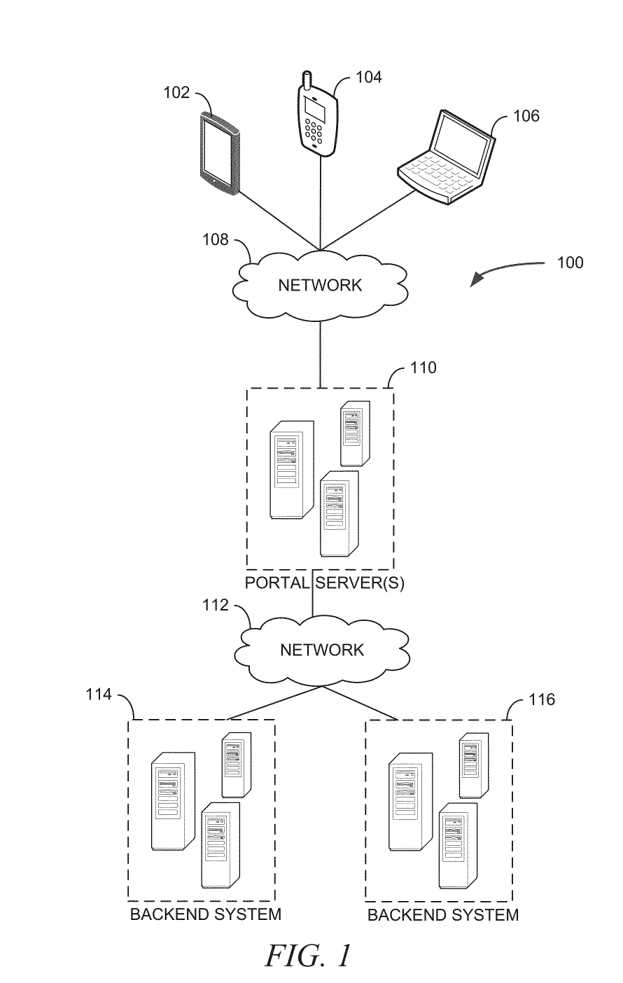

FIG. 1 is a logical block diagram of a computing environment 100, according to an example embodiment. The computing environment 100 includes a number of client computing devices, such as a smart phone 104, a tablet 102, and a personal computer 106. Although only three client computing devices are illustrated, other embodiments may include fewer client computing devices, more client computing devices, and different client computing devices. The client computer devices communicate with one or more portal servers 110 via a network 108. The network 108 may be of one or more wired or wireless networks such as a Local Area Network (LAN), Wide Area Network (WAN), the Internet, a Virtual Private Network (VPN), and the like. The one or more portal servers 110 may also be connected to another network 112, such as a LAN, WAN, the Internet, a System Area Network (SAN), and the like. However, in some embodiments the two networks 108, 112 are the same network. Also connected to the network 112 are one or more backend systems 114, 116. The one or more backend systems 114, 116 may include one or more of ERP, CRM, HRM, BI, and SCM systems, among other system types. Although two backend systems 114, 116 are illustrated, some embodiments may include only a single backend system 114, 116 and other embodiments may include more than two backend systems 114, 116 deployed to one or more server computers at one or more locations.

The one or more portal servers 110 may be a single portal server 110, or a plurality of portal servers 110 that operate in concert or in parallel, to deliver access to computing resources of an organization over a network. In particular, the portal server 110 typically provides a single point of access to all or at least select applications, services, and information of the organization, some of which are provided by one or more backend systems 114, 116. For example, client device (i.e., 102, 104, 106) users may gain access to various informational and computing resource of an organization via the portal server 110 over the network 108, including accessing applications and processes of a backend system 114, 116.

The portal server 110 may provide a web page viewable in a web browser on a client device that provides options for users to access resources such as applications and processes on one or more of the backend systems 114, 116. In some embodiments, the portal server 110 may provide data interfaces over which thin or thick client device apps or applications may submit data processing requests to one or more of the backend systems 114, 116.

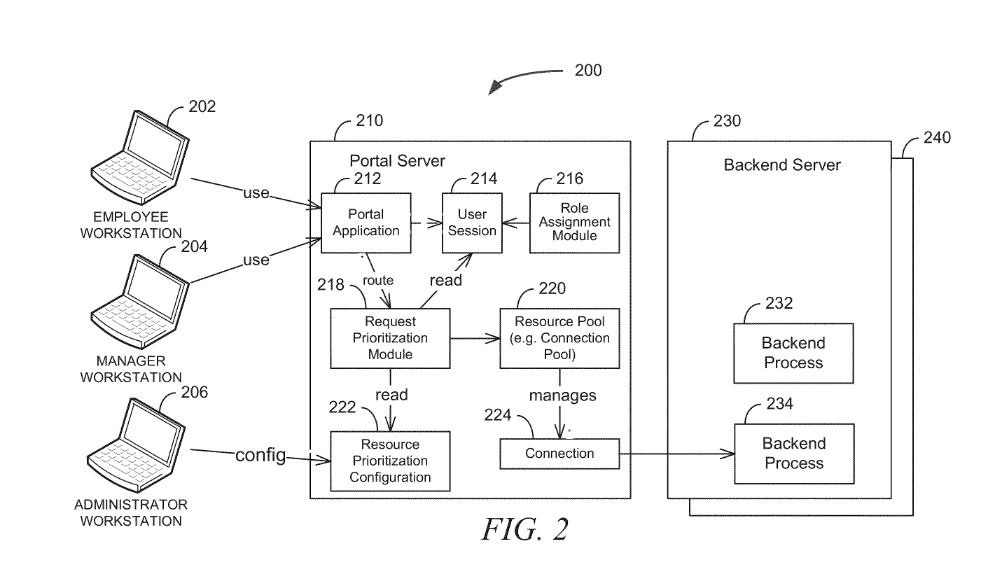

Regardless of whether the client device accesses the portal server 110 via a web browser or a thin or thick client application or app, the portal server 110 operates in part to route the data processing requests, whether the requests be requests for data or invocation of one or more backend system processes, to the appropriate backend system 114, 116. However, the portal server 110, whether it be one or a plurality of portal servers 110, typically has a limited number of connections that may be established and used concurrently with an individual backend system 114, 116 or all backend systems 114, 116. The portal server 110, or each of the portal servers 110 when there are more than one in the particular embodiment, include a process to prioritize received data processing requests. In some embodiments, this prioritization process may be included in an add on data processing request prioritization module or a data processing request prioritization module may be included within a standard deployment, upgrade, or update of portal server 110 software. In some embodiments, the prioritization process includes a rule engine that operates in view of stored request prioritization rules to classify received data processing requests according to one of at least priority levels. FIG. 2 provides further details as to the portal server 110 and functions performed thereby including those of a data processing request prioritization module.

FIG. 2 is a logical block diagram of a computing environment 200, according to an example embodiment. The computing environment 200 includes an employee workstation 202, a manager workstation 204, and an administrator workstation 206 that connect to a portal server 210 via a network (not illustrated). The portal server 210 is an example of a portal server 110 of FIG. 1, according to some embodiments. The portal server 210 is also connected via a network, either the same network connecting the portal server 210 to the workstations 202, 204, 206 or another network, to one or more backend servers 230, 240.

The backend servers 230, 240 are logical or virtual computing devices that host one or more of applications and processes that execute at least in part thereon or store or manage data that may be the subject of a data processing request originating with one of the workstations 202, 204, 206. The one or more applications and processes that execute at least in part on the backend servers 230, 240 may be one or more of ERP, CRM, HRM, BI, and SCM systems, among other applications and processes in various embodiments. For the sake of brevity, only two backend processes 232, 234 that execute on only the backend server 230 are illustrated. These processes 232, 234 may be two of many processes that execute on the backend server 230.

The portal server 210 includes a portal application 212 that operates to receive data processing requests from users, such as from the employee workstation 202 and the manager workstation 204. The portal application 212 may associate data processing requests with user sessions 214 that are maintained and tracked in one or more of memory, storage, databases and other solutions of a computer on which the portal server 210 is deployed or other computing location. The portal application 212, or another process that executes on the portal server 210, may also associate user sessions with one or more roles of a user of the respective user session via a role assignment module 216. Roles of users may be defined within configuration data of the portal server 210, of one or more of the backend servers 230, 240, or elsewhere within the computing resources of an implementing organization such that user roles may only be defined and maintained once within the organization. The portal server 210 also includes a request prioritization module 218 that executes to prioritize data processing resource requests received by the portal application 212 in view of resource prioritization configuration data 222 as may be provided by one or more system administrators via one or more administrator workstations 206. The prioritization configuration data 222 may include data defining prioritization rules, which when applied, grant data processing requests a priority based on one or a combination of certain roles associated with a user from which a data processing request is received, a resource requested, a date or time of the request, and other factors. The request prioritization module 218 executes to prioritize received data processing requests for utilization of a resource pool 220, such as one or more connection 224 pools utilized to connect to one or more of the backend servers 230, 240. In some embodiments, the prioritization module executes to prioritize received data processing requests based on application of the prioritization rules.

In some embodiments, two data processing requests may be received simultaneously by the portal application 212, one from the employee workstation 202 and the other from the manager workstation. The portal application 212 may associate each data processing request with their respective users and determine a role of each user, an employee and a manager respectively. The data processing requests are then routed by the portal application 212 to the request prioritization module 218. The request prioritization module 218 then determines a priority of each request based on the prioritization configuration data 222.

As discussed above, the prioritization configuration data 222 may include rules to prioritize data processing requests. Each data processing request prioritization rule may take into account one or a combination of an identity of a requesting user, a role of the requesting user (i.e., employee, manager, CEO, etc.), a process, application or data element being requested, —a time schedule (such as: last 3 days of the month, every Sunday between 8:00 am-10:00 am), and other such data. One example rule may provide a highest priority to data processing requests from managers while another rule may provide a low priority to data processing requests from employees. Another rule may take into account a combination of user role and a process being requested. For example, a rule may give an accounting backend system request a high priority when received from a user having an accounting role while the rule provides a user having a non-accounting role a lower priority when requesting the same accounting backend system. In a further example of this same accounting backend system related example, the rule may provide the user with the accounting role priority only when the current date is within the first three days of the a month while the accounting-role user is likely performing month-end accounting processes. These and other rules may be defined by system administrators, such as through the administrator workstation 206 to create, update, and delete prioritization configuration data 222. Once defined, the prioritization configuration data 222 may be stored in a database present on the portal server 210 or otherwise accessible to the portal server 210 via a network.

In some embodiments, the request prioritization module 218 includes a rules engine that applies prioritization rules defined within the prioritization configuration data 222. In some embodiments, the rules engine may include a scoring algorithm that applies a plurality of prioritization rules from which scoring values may be obtained. Obtained scoring values may then be combined to determine a score. A priority may then be determined from the determined score based on one or more priority threshold classification values, some of which may be weighted values or have weights applied to them by a rules engine when combining values. In some other embodiments, the rules engine may apply the prioritization rules in a defined sequential order. In such embodiments, when a prioritization rule is determined to apply, a priority classification associated with the prioritization rule is applied and the priority has been determined. The defined sequential order may vary in some embodiments based on a role of the user, a current period (i.e., month-end, year-end, etc.), a resource that is the subject of a data processing request, among other factors. In such embodiment, the priority classification is made based on a first classification rule identified as applicable, and as such, the defined sequential order may cause a data processing request to be prioritized differently based on a role of a user from which the request is received, a time of the day, month, or year within which the request is received, and the like. Other embodiments of the rules engine may include a combination of such classification methodologies, other classification methodologies, and combinations of other classification methodologies and the described methodologies.

Returning to the manager/employee example described above, the request prioritization module 218 after determining a high priority for the data processing request from the manager and a lower priority for the data processing request from the employee then places the requests in a resource pool 220. The resource pool 220 may include one or more sets of pooled resources, such as one or more queues for connection 224 to the backend server 230. In some embodiments, there are two connection 224 queues, a high priority queue and a low priority queue. In this embodiment, the request prioritization module would place the manager data processing request in the high priority queue and the employee data processing request in the low priority queue. In other embodiments, there may be a three or more connection 224 queues defined in the resource pool 220 and the prioritization configuration data 222 may be defined in such embodiments to utilize each of the three or more connection 224 queues. In a further embodiment, there may be only a single connection 224 queue defined in the resource pool 220. In such embodiments, the request prioritization module 218 may place a high priority data processing request ahead of a lower priority data processing request already present in the queue.

Connection 224 queues defined and maintained in the resource pool 220 have a limited number of connections to a backend server 230, 240 that may be utilized at a single time. In some such embodiments, there is a limited number of connections that may be utilized at one time for all backend servers 230, 240, while in other embodiments, there may be a limited number of connections that may be utilized at one time with regard to each of the backend servers. Regardless of how the number of connections is limited, in embodiments where a maximum number of connections is divided into multiple queues for different priorities, a certain number of percentage of possible connections may be reserved for a priority. For example, ten connections or ten percent of possible connections may be reserved for high priority data processing request and the remainder left for low priority requests. Similarly, when there are three types of requests, a number or percentage of possible connections may be reserved for a highest priority, a number or percentage of possible connections may be separately reserved for an intermediate priority, and the remaining connections will be available for low priority requests.

The resource pool 220 manages data processing requests in the various queues. As connections become available, a next data processing request may be released for connection to a backend process 234 of the data processing request. When no connections are available in a respective queue to which a data processing request is assigned, the data processing request will be queue until it reaches the front of the queue and a connection becomes available.

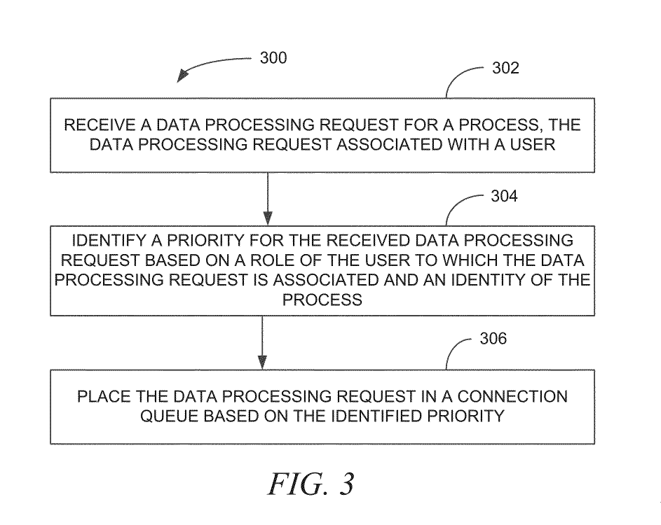

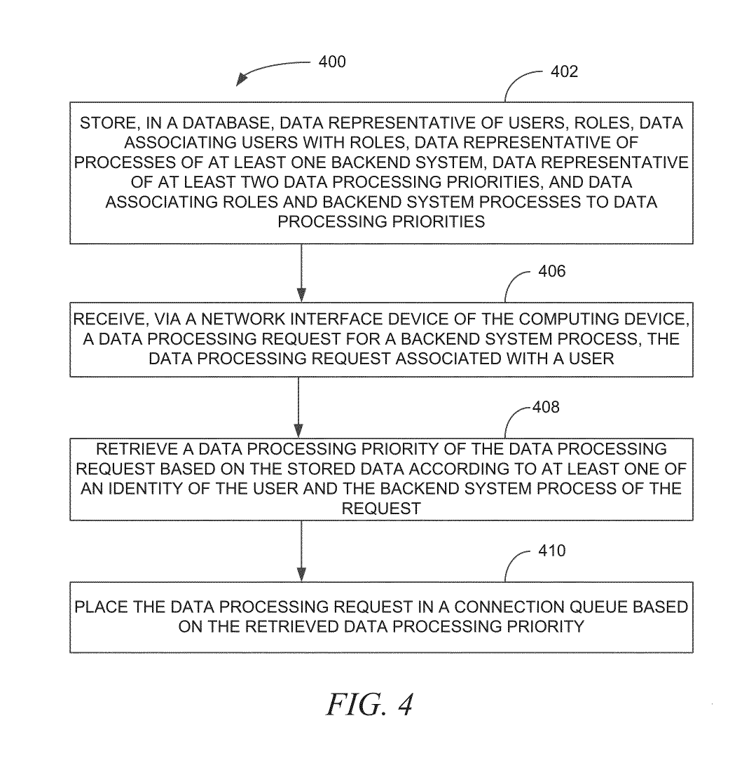

FIG. 3 and FIG. 4, as described below, provide further details of processes that may be performed by a request prioritization module in various embodiments.

FIG. 3 is a block flow diagram of a method 300, according to an example embodiment. The method 300 will be described not only with reference to FIG. 3, but also with reference to the computing environment 200 of FIG. 2, where appropriate. The method 300 is an example of a method that may be performed, in whole or in part, by a request prioritization module 218 present on or accessed by a portal server 210. The method 300 includes receiving 302, via a network in a prioritization module 218 executable by at least one processor of a computing system such as a portal server 210, a data processing request for a process, such as backend process 234. The process is typically a process that executes on a different computing device than that on which the method 300 is performed, such as a process 232, 234 of a backend system or server 230, 240. Further, the data processing request is typically associated with a user, whether that user be human or logical, such as a process executing on a different computing device. The method 300 may then identify 304 a priority for the received 302 data processing request based on a role of the user to which the data processing request is associated and an identity of the process. The method 300 further places 306 the data processing request in a connection queue, such as resource pool 220, based on the identified 304 priority. In some embodiments, the connection queue is a queue that manages a finite number of network connection threads between a portal server on which the method 300 is implemented and a backend computing system.

In some embodiments of the method 300, identifying 304 the priority for the received 302 data processing request based on the role of the user to which the data processing request is associated and the identity of the process includes retrieving data on which the an identification 304 decision may be made. For example, data may be retrieved from a database that is data representative of at least one role based on user identifying data and data representative of the priority based on the retrieved data representative of the at least one role. The retrieved data, in some embodiments, include one or both of data representative of the at least one user role and data representative of the priority based in part on a current date, time, or date and time. In some embodiments, when retrieving data representative of the priority fails to return data representative of a priority, the priority is identified as a default priority. A default priority may be a lowest priority, a highest priority, or as otherwise configured or implemented within a particular embodiment.

In some embodiments of the method 300, identifying 304 the priority for the received 302 data processing request by retrieving data representative of the priority triggers application or one or more context-discovery rules of a plugin. The context-discovery rules of the plugin are applied to determine a context of the request and a priority associated therewith. Discovery of the context may include evaluating log data of the portal server 210 to identify recently called or invoked processes, systems, performed tasks, and the like to determine what a user from whom the data processing request was received 302 is doing. Based on an evaluation of the log data or other data that may provide data useful to determine what the user is doing or what context they are working in, the context of the received 302 data processing request may be determined. The context may then be utilized to identify and set the priority. In some embodiments, the priority is a priority identified according to a configuration setting of the plugin.

In some embodiments of the method 300, placing 306 the data processing request in the connection queue based on the identified priority includes placing the data processing request in one of at least two connection queues. In such embodiments, the queue within which the data processing request is placed 306 is selected based on the identified priority.

FIG. 4 is a block flow diagram of a method 400, according to an example embodiment. The method 400 is an example of a method that may be performed, in whole or in part, by a request prioritization module present on or accessed by a portal server.

The method 400 includes storing 402, such as in a database, data representative of users, roles, data associating users with roles, data representative of processes of at least one backend system, data representative of at least two data processing priorities, data associating roles and backend system processes, and optionally time schedules to data processing priorities. This stored 402 data, such as the data representative of users and their roles, may be present in a computing environment of an organization implementing the method 400 for purposes other than prioritization of data processing requests. For example, the data representative of users and their roles may be a part of a security related portion or module of another system that may be utilized to provide users access to systems, create email and other messaging accounts, and the like.

The method 400 further includes receiving 406 a data processing request for a backend system process. The received 406 data processing request is typically associated with a user. The method 400 may then retrieve 408 a data processing priority for the data processing request based on the stored 402 data according to at least one of an identity of the user and the backend system process of the request. The retrieving may further take into account one or both of a data and time of the request. Based on the retrieved 408 priority, the method 400 then places 410 the data processing request in a connection queue. Some embodiments further include transmitting the data processing request to the backend system when the data processing request reaches a front of the connection queue within which the data processing request was placed 410.

In some embodiments, the connection queue into which the method 400 places 410 the data processing request includes processes to manage the connection queue. For example, such processes may operate to receive the data processing request placed 410 into the connection queue and maintain data processing requests placed 410 in the connection queue in a memory device until the data processing request is released for processing. Such processes of the connection queue may further monitor utilized connections and release the data processing request for processing when a connection is available.

In some embodiments, placing 410 the data processing request in the connection queue based on the retrieved 408 data processing priority includes placing the data processing request in one of at least two connection queues selected based on the identified data processing priority.

In some embodiments, the stored 402 data associating roles and backend system processes to data processing priorities further includes active period data. The active period data in such embodiments identifies at least one period during which the associations of roles to data processing priorities and backend system processes to data processing priorities are active. For example, during certain periods of a month, certain periods following a quarter, and certain periods during a year, some processes may be considered very important, such as monthly or quarterly invoicing processes, month-end accounting or data warehousing processes, year-end accounting and tax-related processes, among other. Such processes may be associated with data processing priorities that are active only during certain periods.

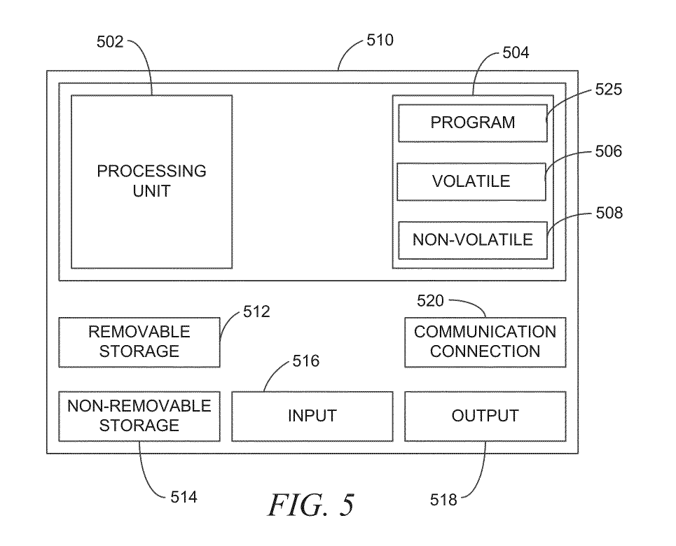

FIG. 5 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 510, may include a processing unit 502, memory 504, removable storage 512, and non-removable storage 514. Although the example computing device is illustrated and described as computer 510, the computing device may be in different forms in different embodiments. For example, the computing device may instead be a smartphone, a tablet, or other computing device including the same or similar elements as illustrated and described with regard to FIG. 5. Further, although the various data storage elements are illustrated as part of the computer 510, the storage may also or alternatively include cloud-based storage accessible via a network, such as the Internet.

Returning to the computer 510, memory 504 may include volatile memory 506 and non-volatile memory 508. Computer 510 may include—or have access to a computing environment that includes a variety of computer-readable media, such as volatile memory 506 and non-volatile memory 508, removable storage 512 and non-removable storage 514. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 510 may include or have access to a computing environment that includes input 516, output 518, and a communication connection 520. The input 516 may include one or more of a touchscreen, touchpad, mouse, keyboard, camera, and other input devices. The computer may operate in a networked environment using a communication connection 520 to connect to one or more remote computers, such as database servers, web servers, and other computing device. An example remote computer may include a personal computer (PC), server, router, network PC, a peer device or other common network node, or the like. The communication connection 520 may be a network interface device such as one or both of an Ethernet card and a wireless card or circuit that may be connected to a network. The network may include one or more of a Local Area Network (LAN), a Wide Area Network (WAN), the Internet, and other networks.

Computer-readable instructions stored on a computer-readable medium are executable by the processing unit 502 of the computer 510. A hard drive (magnetic disk or solid state), CD-ROM, and RAM are some examples of articles including a non-transitory computer-readable medium. For example, various computer programs 525 or apps, such as one or more applications and modules implementing one or more of the methods illustrated and described herein or an app or application that executes on a mobile device or is accessible via a web browser, may be stored on a non-transitory computer-readable medium. In some embodiments, the computer 510 is a portal server and the computer program 525 is a data processing request prioritization module that executes on the portal server to allocate connections for data processing requests received by the portal server to one or more backend systems.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
receiving, via a network in a prioritization module executable by at least one processor of a computing system, a data processing request for a process, the data processing request associated with a user;
identifying a priority for the received data processing request based on a role of the user to which the data processing request is associated and an identity of the process; and
placing the data processing request in a connection queue based on the identified priority, the connection queue including processes to receive data the processing request, maintain data processing requests placed in the connection queue in a memory device of the computing system at least until the data processing request is released for processing, monitor utilized connections, and release the data processing request for processing when a connection is available.

2. The method of claim 1, wherein:
the computing system on which the prioritization module executes is a portal server and the process executes on a backend computing system; and
the connection queue is a queue that manages a finite number of network connection threads between the portal server and the backend computing system.

3. The method of claim 1, wherein identifying the priority for the received data processing request based on the role of the user to which the data processing request is associated and the identity of the process includes:
retrieving, from data storage, data representative of at least one role based on user identifying data; and
retrieving, from the data storage, data representative of the priority based on the retrieved data representative of the at least one role.

4. The method of claim 3, wherein retrieving at least one of the data representative of the at least one role and the data representative of the priority are preformed based on a current date/time data element.

5. The method of claim 3, wherein when retrieving data representative of the priority triggers application or one or more context-discovery rules of a plugin to determine a context of the request and a priority associated therewith.

6. The method of claim 5, wherein the priority is a priority identified according to a configuration setting of the plugin.

7. The method of claim 1, wherein the user is a logical user.

8. The method of claim 1, wherein placing the data processing request in the connection queue based on the identified priority includes:
placing the data processing request in one of at least two connection queues, the one of the at least two connection queues into which the data processing request is placed selected based on the identified priority.

9. A non-transitory computer-readable medium, with instructions stored thereon, which when executed by at least one processor of a computing device, cause the computing device to:
store, in a database, data representative of users, roles, data associating users with roles, data representative of processes of at least one backend system, data representative of at least two data processing priorities, and data associating roles and backend system processes to data processing priorities;
receive, via a network interface device of the computing device, a data processing request for a backend system process, the data processing request associated with a user;
retrieve a data processing priority of the data processing request based on the stored data according to at least one of an identity of the user and the backend system process of the request; and
place the data processing request in a connection queue based on the retrieved data processing priority, the connection queue managed by at least one process to receive the data processing request, maintain data processing requests placed in the connection queue in a memory device of the computing system at least until the data processing request is released for processing, monitor utilized connections, and release the data processing request for processing when a connection is available.

10. The non-transitory computer-readable medium of claim 9, further comprising:
transmit, via the network interface device, the data processing request to the backend system when the data processing request reaches a front of the connection queue within which the data processing request was placed.

11. The non-transitory computer-readable medium of claim 9, wherein placing the data processing request in the connection queue based on the retrieved data processing priority includes:
placing the data processing request in one of at least two connection queues, the one of the at least two connection queues into which the data processing request is placed selected based on the identified data processing priority.

12. The non-transitory computer-readable medium of claim 9, wherein when the retrieving of the data processing priority fails, setting the priority as a default data processing priority.

13. The non-transitory computer-readable medium of claim 9, wherein the data associating roles and backend system processes to data processing priorities further includes active period data identifying at least one period during which associations of roles to data processing priorities and backend system processes to data processing priorities are active.

14. The non-transitory computer-readable medium of claim 13, wherein retrieving the data processing priority of the data processing request based on the stored data according to at least one of an identity of the user and the backend system process of the request retrieves an active data processing priority based on the stored active period data.

15. The non-transitory computer-readable medium of claim 9, wherein the data associating roles and backend system processes to data processing priorities includes data associating a role to one data processing priority of the at least two data processing priorities.

16. A system comprising:
at least one processor, at least one memory device, at least one network interface device; and
a data processing request prioritization module stored in the at least one memory device and executable by the at least one processor to:
receive, via the at least one network interface device, a data processing request for a backend system process, the data processing request associated with a user;
identify a priority for the received data processing request based on a role of the user to which the data processing request is associated, a backend system on which the backend system process exists, and an identity of the backend system process; and
place the data processing request in a connection queue in the at least one memory device based on the identified priority.

17. The system of claim 16, wherein:
the connection queue is a queue implemented by the data processing request prioritization module to manage a finite number of network connection threads between the system and the backend system on which the backend system process exists.

18. The system of claim 17, wherein the data processing request prioritization module manages a plurality of connection queues including at least two connection queues for each of at least two priorities for connection to the backend system on which the backend system process exists and at least one connection queue for at least one priority for connection to at least one other backend system.

19. The system of claim 16, wherein identifying the priority for the received data processing request based on the role of the user to which the data processing request is associated and the identity of the backend system process includes:
retrieving, from a database, data representative of at least one role based on user identifying data; and
retrieving, from the database, data representative of the priority based on the retrieved data representative of the at least one role.

20. The system of claim 19, wherein retrieving data representative of the priority is further based on identifying data of the backend system process.
